(19) United States
(12) Patent Application Publication
(10) Pub. No.: US 2017/0161742 A1
(43) Pub. Date: Jun. 8, 2017

(54) SYSTEMS AND METHODS FOR PROCESSING ELECTRONIC PAYMENT AUTHORIZATION OF ONLINE CREDIT CARD TRANSACTIONS INVOLVING VIRTUAL CREDIT CARDS

(71) Applicant: Lavasoft Canada Inc., Ville St-Laurent (CA)

(72) Inventors: Alexander Martin-Bale, Ville St-Laurent (CA); Daniel Assouline, Ville St-Laurent (CA)

(21) Appl. No.: 15/372,533

(22) Filed: Dec. 8, 2016

Related U.S. Application Data
(60) Provisional application No. 62/264,498, filed on Dec. 8, 2015.

(51) Int. Cl. G06Q 20/40; G06Q 20/02

(52) U.S. Cl. CPC G06Q 20/405; G06Q 20/02

(57) ABSTRACT

Systems and methods of processing electronic payment authorization are disclosed. The system includes a computing device where an online payment transaction is initiated. The computing device transmits a payment authorization request to a merchant server, and the merchant server transmits a corresponding authorization request to a virtual issuer server. Upon receiving the corresponding authorization request, the virtual issuer server transmits a request to an origin issuer server to obtain a first indication of whether the online payment transaction initiated at the computing device should be approved. In parallel with the transmission of the request to obtain the first indication, there is a transmission of a request to a third-party advisor server to obtain a second indication of whether the online payment transaction initiated at the computing device should be approved. Based on one or more of the first indication and the second indication, it is determined whether to approve the online payment transaction initiated at the computing device.

### CROSS-REFERENCE TO RELATED APPLICATIONS

This application claims priority to U.S. provisional patent application No. 62/264,498, filed on Dec. 8, 2015, the entire contents of which is incorporated by reference herein.

### FIELD OF THE DISCLOSURE

This present disclosure relates generally to systems and methods for performing electronic payment authorization, and specifically, to systems and methods for processing electronic payment authorization of online credit card transactions involving virtual credit cards.

### BACKGROUND

When processing payment for certain types of prepaid credit cards (also known as “virtual” or “proxy” credit cards), the payment authorization communication flow traditionally proceeds in a linear process. For example, in an online electronic commerce (“e-commerce”) transaction, a client computing device may access a merchant server to enter the credit card information (e.g., the credit card number, expiry date, name on the card, verification code) for processing payment at the merchant server. The merchant server may then submit an authorization request to a virtual issuer server (e.g., the server of the bank issuing the prepaid credit card) via the credit card's payment network (e.g., the Visa™ or MasterCard™ payment network).

Upon receipt of the payment authorization request, the virtual issuer server may perform various actions to generate an approval or denial message for returning to the merchant server. It may also forward a request for authorization advice (referred to herein also as an “indication” of whether the online payment transaction should be approved) to a third-party advisor server. The third-party advisor server may be a server associated with provider of virtual credit cards, for example.

Upon transmitting the request for authorization advice, the virtual issuer server waits for a response from the third-party advisor server. If the authorization advice indicates that the payment transaction should be approved, the virtual issuer server then proceeds to submit a further authorization request to an origin issuer server (e.g., an authorization server associated with the credit card company itself). Upon receiving a response from the origin issuer server, the virtual issuer server may then return an approval or denial message to the merchant server.

Typically, when the merchant server sends its authorization request to the virtual issuer server, the virtual issuer server has a time-limited window of five (5) seconds to respond to the merchant server with the approval or denial message. At the same time, the origin issuer server may take up to five (5) seconds to respond to the further authorization request submitted to it by the virtual issuer server. As a result, in the traditional linear message flow, the requirement for the virtual issuer server to send an authorization request to the origin issuer server and await its response may consume a large portion of the five (5) second window allotted to the virtual issuer server for responding to the merchant server. This reduces the amount of time available to the third-party advisor server to perform processing related to providing authorization advice, and thus may hamper the ability of the third-party advisor server to provide fulsome advice related to the transaction.

There is thus a need for improved systems and methods of processing electronic payment authorization of online credit card transactions involving virtual credit cards.

### BRIEF DESCRIPTION OF THE DRAWINGS

Non-limiting examples of various embodiments of the present disclosure will next be described in relation to the drawings, in which:

FIG. 1 is a block diagram of a system for processing electronic payment authorization, in accordance with at least one embodiment of the present invention;

FIG. 2 is a flowchart diagram illustrating steps performed during a method of processing electronic payment authorization in which the virtual issuer server sends a request for authorization advice to a third-party advisor server in parallel with an authorization request to the origin issuer server, in accordance with at least one embodiment of the present invention;

FIG. 3 is a flowchart diagram illustrating steps performed during a method of processing electronic payment authorization in which the client computing device sends a request for authorization advice to a third-party advisor server in parallel with an authorization request to a merchant server, in accordance with at least one embodiment of the present invention;

FIG. 4 is a flowchart diagram illustrating steps performed by a third-party advisor server to detect fraud during a method of processing electronic payment authorization, in accordance with at least one embodiment of the present invention;

FIG. 5 is a flowchart diagram illustrating steps performed during a method of processing electronic payment authorization in which the third-party advisor server identifies an alternate origin issuer server for processing the online payment transaction, in accordance with at least one embodiment of the present invention; and

FIG. 6 is an example user interface showing a web browser application providing a user interface control for selecting payment using a virtual credit card, in accordance with at least one embodiment of the present invention.

### DETAILED DESCRIPTION

In a first broad aspect of the present disclosure, there is provided a method of processing electronic payment authorization. The method includes: receiving input at a computing device to initiate an online payment transaction; transmitting a payment authorization request for the online payment transaction from the computing device to a merchant server, wherein the merchant server transmits a corresponding authorization request to a virtual issuer server, and upon receiving the corresponding authorization request, the virtual issuer server transmits a request to an origin issuer server to obtain a first indication of whether the online payment transaction initiated at the computing device should be approved; transmitting a request to a third-party advisor server to obtain a second indication of whether the online payment transaction initiated at the computing device should be approved, wherein the request to the third-party advisor server is transmitted in parallel with the transmitting of the request to the origin issuer server and prior to a response being received from the origin issuer server; determining, based on one or more of the first indication and the second indication, whether to approve the online payment transaction initiated at the computing device; and indicating at the computing device whether the online payment transaction is approved.

In some embodiments, the transmitting of the request to the third-party advisor server is performed at the virtual issuer server, and the virtual issuer server receives the first indication and the second indication from the origin issuer server and the third-party advisor server respectively. In some embodiments, the determining whether to approve the online payment transaction is performed at the virtual issuer server, and a result of the determining is provided to the merchant server in response to the corresponding authorization request transmitted from the merchant server to the virtual issuer server. In some embodiments, upon receipt at the merchant server, the result of the determining is relayed to the computing device in response to the payment authorization request transmitted from the computing device to the merchant server.

In some embodiments, the transmitting of the request to the third-party advisor server is performed at the computing device, and the computing device receives the second indication from the third-party advisor server. In some embodiments, the online payment transaction is initiated using a browser application executing on the computing device, and the transmitting of the request to the third-party advisor server is performed by a plug-in installed for execution with the browser application. In some embodiments, the determining whether to approve the online payment transaction is performed at the computing device.

In some embodiments, the virtual issuer server receives the first indication from the origin issuer server, and in response to the payment authorization request transmitted from the computing device to the merchant server, the first indication is relayed back to the computing device from the virtual issuer server via the merchant server.

In some embodiments, the request transmitted to the third-party advisor server includes information from the online payment transaction. In some embodiments, the information from the online payment transaction includes one or more of the following: a Uniform Resource Locator (URL) of the merchant server, an Internet Protocol (IP) address of the merchant server, an IP address of the computing device, personal information recorded for the transaction, and details about the credit card used in the online payment transaction.

In some embodiments, the method further includes: receiving, from the third-party advisor server, the second indication of whether the online payment transaction initiated at the computing device should be approved; wherein the determining whether to approve the online payment transaction initiated at the computing device is performed on the sole basis of the second indication, prior to the first indication being received from the origin issuer server.

In some embodiments, the method further includes: in response to the request transmitted to the third-party advisor server, receiving information identifying an alternate origin issuer server for processing the online payment transaction initiated at the computing device; and transmitting a request to the alternate origin issuer server to obtain a third indication of whether the online payment transaction initiated at the computing device should be approved; wherein, the determining whether to approve the online payment transaction initiated at the computing device is performed based in part on the third indication received from the alternate origin issuer server.

In some embodiments, the method further includes: receiving, from the origin issuer server, the first indication of whether the online payment transaction initiated at the computing device should be approved; and dismissing the first indication when performing the determining whether to approve the online payment transaction initiated at the computing device.

In another broad aspect of the present disclosure, there is provided a server for processing electronic payment authorization, the server including a processor and a memory for storing instructions which, when executed by the processor, cause the processor to: receive an authorization request from a merchant server, the authorization request corresponding to a payment authorization request transmitted from a computing device when the computing device received input to initiate an online payment transaction; upon receipt of the authorization request, transmit a request to an origin issuer server to obtain a first indication of whether the online payment transaction initiated at the computing device should be approved; transmit a request to a third-party advisor server to obtain a second indication of whether the online payment transaction initiated at the computing device should be approved, wherein the request to the third-party advisor server is transmitted in parallel with the transmitting of the request to the origin issuer server and prior to a response being received from the origin issuer server; and receive the first indication and the second indication from the origin issuer server and the third-party advisor server respectively.

In some embodiments, the processor is further configured to: based on one or more of the first indication and the second indication, determine whether to approve the online payment transaction initiated at the computing device; and provide a result of the determining to the merchant server, in response to the receipt of the authorization request from the merchant server.

In some embodiments, upon receipt at the merchant server, the result of the determining is relayed to the computing device in response to the payment authorization request being transmitted from the computing device when the computing device received input to initiate the online payment transaction.

In some embodiments, the request transmitted to the third-party advisor server includes information from the online payment transaction. In some embodiments, the information from the online payment transaction includes one or more of the following: a Uniform Resource Locator (URL) of the merchant server, an Internet Protocol (IP) address of the merchant server, an IP address of the computing device, personal information recorded for the transaction, and details about the credit card used in the online payment transaction.

In some embodiments, the processor is further configured to perform the determining of whether to approve the online payment transaction initiated at the computing device on the sole basis of the second indication, prior to the first indication being received from the origin issuer server.

In some embodiments, the processor is further configured to: in response to the request transmitted to the third-party advisor server, receive information identifying an alternate origin issuer server for processing the online payment transaction initiated at the computing device; and transmit a request to the alternate origin issuer server to obtain a third indication of whether the online payment transaction initiated at the computing device should be approved; wherein, the determining whether to approve the online payment transaction initiated at the computing device is performed based in part on the third indication received from the alternate origin issuer server.

In some embodiments, the processor is further configured to: dismiss the first indication when performing the determining whether to approve the online payment transaction initiated at the computing device.

In another broad aspect of the present disclosure, there is provided a computer readable medium storing instructions for processing electronic payment authorization, wherein when the instructions are executed by a processor of a server, the instructions cause the processor to: receive an authorization request from a merchant server, the authorization request corresponding to a payment authorization request transmitted from a computing device when the computing device received input to initiate an online payment transaction; upon receipt of the authorization request, transmit a request to an origin issuer server to obtain a first indication of whether the online payment transaction initiated at the computing device should be approved; transmit a request to a third-party advisor server to obtain a second indication of whether the online payment transaction initiated at the computing device should be approved, wherein the request to the third-party advisor server is transmitted in parallel with the transmitting of the request to the origin issuer server and prior to a response being received from the origin issuer server; and receive the first indication and the second indication from the origin issuer server and the third-party advisor server respectively.

In another broad aspect of the present disclosure, there is provided a method of processing electronic payment authorization at a server, the method including: receiving an authorization request from a merchant server, the authorization request corresponding to a payment authorization request transmitted from a computing device when the computing device received input to initiate an online payment transaction; upon receipt of the authorization request, transmitting a request to an origin issuer server to obtain a first indication of whether the online payment transaction initiated at the computing device should be approved; transmitting a request to a third-party advisor server to obtain a second indication of whether the online payment transaction initiated at the computing device should be approved, wherein the request to the third-party advisor server is transmitted in parallel with the transmitting of the request to the origin issuer server and prior to a response being received from the origin issuer server; and receiving the first indication and the second indication from the origin issuer server and the third-party advisor server respectively.

In another broad aspect of the present disclosure, there is provided a computing device including a processor and a memory for storing instructions which, when executed by the processor, cause the processor to: receive input to initiate an online payment transaction; transmit a payment authorization request for the online payment transaction to a merchant server, wherein the merchant server transmits a corresponding authorization request to a virtual issuer server, and upon receiving the corresponding authorization request, the virtual issuer server transmits a request to an origin issuer server to obtain a first indication of whether the online payment transaction initiated at the computing device should be approved; transmit a request to a third-party advisor server to obtain a second indication of whether the online payment transaction initiated at the computing device should be approved, wherein the request to the third-party advisor server is transmitted in parallel with the transmitting of the request to the merchant server and prior to a response being received from the merchant server; receive the second indication from the third-party advisor server; determine, based on one or more of the first indication and the second indication, whether to approve the online payment transaction initiated at the computing device; and indicate at the computing device whether the online payment transaction is approved.

In some embodiments, the online payment transaction is initiated using a browser application executing on the computing device, and wherein the transmitting of the request to the third-party advisor server is performed by a plug-in installed for execution with the browser application.

In some embodiments, the virtual issuer server receives the first indication from the origin issuer server, and in response to the payment authorization request transmitted from the computing device to the merchant server, the processor is further configured to: receive the first indication from the merchant server, as relayed from the virtual issuer server.

In some embodiments, the request transmitted to the third-party advisor server includes information from the online payment transaction. In some embodiments, the information from the online payment transaction includes one or more of the following: a Uniform Resource Locator (URL) of the merchant server, an Internet Protocol (IP) address of the merchant server, an IP address of the computing device, personal information recorded for the transaction, and details about the credit card used in the online payment transaction.

In some embodiments, the processor is further configured to determine whether to approve the online payment transaction on the sole basis of the second indication, prior to the first indication being received from the origin issuer server.

In some embodiments, the processor is further configured to: in response to the request transmitted to the third-party advisor server, receive information identifying an alternate origin issuer server for processing the online payment transaction initiated at the computing device; and transmit a request to the alternate origin issuer server to obtain a third indication of whether the online payment transaction initiated at the computing device should be approved; wherein, the determining whether to approve the online payment transaction initiated at the computing device is performed based in part on the third indication received from the alternate origin issuer server.

In some embodiments, the processor is further configured to: dismiss the first indication when performing the determining whether to approve the online payment transaction initiated at the computing device.

In another broad aspect of the present disclosure, there is provided a computer readable medium storing instructions for processing electronic payment authorization, wherein when the instructions are executed by a processor of a computing device, the instructions cause the processor to: receive input to initiate an online payment transaction; transmit a payment authorization request for the online payment transaction to a merchant server, wherein the merchant server transmits a corresponding authorization request to a virtual issuer server, and upon receiving the corresponding authorization request, the virtual issuer server transmits a request to an origin issuer server to obtain a first indication of whether the online payment transaction initiated at the computing device should be approved; transmit a request to a third-party advisor server to obtain a second indication of whether the online payment transaction initiated at the computing device should be approved, wherein the request to the third-party advisor server is transmitted in parallel with the transmitting of the request to the merchant server and prior to a response being received from the merchant server; receive the second indication from the third-party advisor server; determine, based on one or more of the first indication and the second indication, whether to approve the online payment transaction initiated at the computing device; and indicate at the computing device whether the online payment transaction is approved.

In another broad aspect of the present disclosure, there is provided a method of processing electronic payment authorization at a computing device, the method including: receiving input to initiate an online payment transaction; transmitting a payment authorization request for the online payment transaction to a merchant server, wherein the merchant server transmits a corresponding authorization request to a virtual issuer server, and upon receiving the corresponding authorization request, the virtual issuer server transmits a request to an origin issuer server to obtain a first indication of whether the online payment transaction should be approved; transmitting a request to a third-party advisor server to obtain a second indication of whether the online payment transaction should be approved, wherein the request to the third-party advisor server is transmitted in parallel with the transmitting of the request to the merchant server and prior to a response being received from the merchant server; receiving the second indication from the third-party advisor server; determining, based on one or more of the first indication and the second indication, whether to approve the online payment transaction; and indicating whether the online payment transaction is approved.

In another broad aspect of the present disclosure, there is provided a server including a processor and a memory storing instructions for execution by the processor, wherein when the instructions are executed by the processor, the instructions cause the processor to: receive a request to obtain a second indication of whether an online payment transaction initiated at a computing device should be approved, the second indication having been transmitted in parallel with the transmitting of a request to obtain a first indication of whether the online payment transaction initiated at the computing device should be approved; and in response to the request to obtain the second indication, transmit the second indication of whether the online payment transaction initiated at the computing device should be approved; wherein, one or more of the first indication and the second indication is used to determine whether to approve the online payment transaction initiated at the computing device.

In some embodiments the request to obtain the second indication is received from the virtual issuer server, and the transmitting of the second indication is to the virtual issuer server.

In some embodiments, the request to obtain the second indication is received from the computing device, and the transmitting of the second indication is to the computing device.

In some embodiments, the received request to obtain the second indication includes information from the online payment transaction. In some embodiments, the information from the online payment transaction includes one or more of the following: a Uniform Resource Locator (URL) of the merchant server, an Internet Protocol (IP) address of a merchant server, an IP address of the computing device, personal information recorded for the transaction, and details about the credit card used in the online payment transaction.

In some embodiments, the determining whether to approve the online payment transaction initiated at the computing device is performed on the sole basis of the second indication.

In some embodiments, the processor is further configured to: transmit information identifying an alternate origin issuer server for processing the online payment transaction initiated at the computing device; wherein a request is transmitted to the alternate origin issuer server to obtain a third indication of whether the online payment transaction initiated at the computing device should be approved, and wherein, the determining whether to approve the online payment transaction initiated at the computing device is performed based in part on the third indication received from the alternate origin issuer server.

In another broad aspect of the present disclosure, there is provided a computer readable medium storing instructions for processing electronic payment authorization, wherein when the instructions are executed by a processor of a third-party advisor server, the instructions cause the processor to: receive a request to obtain a second indication of whether an online payment transaction initiated at a computing device should be approved, the second indication having been transmitted in parallel with the transmitting of a request to obtain a first indication of whether the online payment transaction initiated at the computing device should be approved; and in response to the request to obtain the second indication, transmit the second indication of whether the online payment transaction initiated at the computing device should be approved; wherein, one or more of the first indication and the second indication is used to determine whether to approve the online payment transaction initiated at the computing device.

In another broad aspect of the present disclosure, there is provided a method of processing electronic payment authorization at a server, the method including: receiving a request to obtain a second indication of whether an online payment transaction initiated at a computing device should be approved, the second indication having been transmitted in parallel with the transmitting of a request to obtain a first indication of whether the online payment transaction initiated at the computing device should be approved; and in response to the request to obtain the second indication, transmitting the second indication of whether the online payment transaction initiated at the computing device should be approved; wherein, one or more of the first indication and the second indication is used to determine whether to approve the online payment transaction initiated at the computing device.

In another broad aspect of the present disclosure, there is provided a system for processing electronic payment authorization, the system including: a computing device configured to receive input to initiate an online payment transaction, wherein the computing device is configured to transmit a payment authorization request for the online payment transaction to a merchant server, and the merchant server transmits a corresponding authorization request; a virtual issuer server for receiving the corresponding authorization request from the merchant server, wherein upon receipt of the corresponding authorization request, the virtual issuer server transmits a request to an origin issuer server to obtain a first indication of whether the online payment transaction initiated at the computing device should be approved; and a third-party advisor server for receiving a request to obtain a second indication of whether an online payment transaction initiated at a computing device should be approved, the second indication having been transmitted in parallel with the transmitting, to the origin issuer server, of the request to obtain a first indication of whether the online payment transaction initiated at the computing device should be approved; wherein one or more of the first indication and the second indication is used to determine whether to approve the online payment transaction initiated at the computing device.

In some embodiments, the request to obtain the second indication is received at the third-party advisor server from the virtual issuer server, and in response to the request to obtain the second indication, the third-party advisor server transmits the second indication of whether the online payment transaction initiated at the computing device should be approved to the virtual issuer server. In some embodiments, the virtual issuer server performs the determination of whether to approve the online payment transaction initiated at the computing device, based on one or more of the first indication and the second indication.

In some embodiments, the request to obtain the second indication is received at the third-party advisor server from the computing device, and in response to the request to obtain the second indication, the third-party advisor server transmits the indication of whether the online payment transaction initiated at the computing device should be approved to the computing device. In some embodiments, the computing device performs the determination of whether to approve the online payment transaction initiated at the computing device, based on one or more of the first indication and the second indication.

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, certain steps, signals, protocols, software, hardware, networking infrastructure, circuits, structures, techniques, well-known methods, procedures and components have not been described or shown in detail in order not to obscure the embodiments generally described herein.

Furthermore, this description is not to be considered as limiting the scope of the embodiments described herein in any way. It should be understood that the detailed description, while indicating specific embodiments, are given by way of illustration only, since various changes and modifications within the scope of the disclosure will become apparent to those skilled in the art from this detailed description.

The embodiments of the methods described herein may be implemented in hardware or software, or a combination of both. In some cases, embodiments may be implemented in one or more computer programs executing on one or more programmable computing devices (e.g., the various devices and servers discussed below) including at least one processor (e.g., a microprocessor), a data storage device (including in some cases volatile and non-volatile memory and/or data storage elements), at least one communications interface (e.g., a network interface card for wired or wireless network communications), at least one input device, and at least one output device. For example and without limitation, the programmable computing devices may be a personal computer, laptop, personal data assistant, cellular telephone, smartphone device, tablet computer, smartwatch, and/or wireless device. Additional examples of programmable computing devices are also discussed below. Program code is applied to input data to perform the functions described herein and generate output information. The output information is applied to one or more output devices.

Those of skill in the art will understand that the following description of illustrative embodiments of the disclosure does not limit the implementation of embodiments of the disclosure to any particular computer programming language. For example, in some embodiments, each program, module, or application may be implemented in a high level procedural or object oriented programming and/or scripting language to communicate with a computer system. However, the programs can be implemented in assembly or machine language, if desired. In any case, the language may be a compiled or interpreted language.

More specifically, embodiments of the disclosure may be implemented in any computer programming language provided that the operating system (O/S) provides the facilities that may support the present disclosure. For instance, an embodiment of the present disclosure may be implemented in part in the JAVA™ computer programming language (or other computer programming languages such as C or C++), but the web-related components of the present disclosure may more commonly be implemented using scripting languages typical for web development environments (e.g., JavaScript for client-side applications and PHP: Hypertext Preprocessor (PHP)/Python/Perl for server-side applications). Those skilled in the art will also appreciate that any limitations presented by such an embodiment would be a result of a particular type of operating system or computer programming/scripting language and would not be a limitation of the present disclosure.

In some embodiments, the computing devices and methods as described herein may also be implemented as a transitory or non-transitory computer-readable storage medium configured with a computer program, wherein the storage medium so configured causes a computing device to operate in a specific and predefined manner to perform at least some of the functions as described herein. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled, non-compiled, bytecode, or other forms in which the instructions may be interpreted or translated.

Moreover, the subject system may be implemented as one or more software components stored on one or more computer servers that are accessible via one or more client machines in a client-server architecture. In such case, the system can be considered to be a hosted software offering or a software service in a software-as-a-service deployment.

Additional aspects and advantages of the present disclosure will be apparent in view of the description which follows.

### Overview

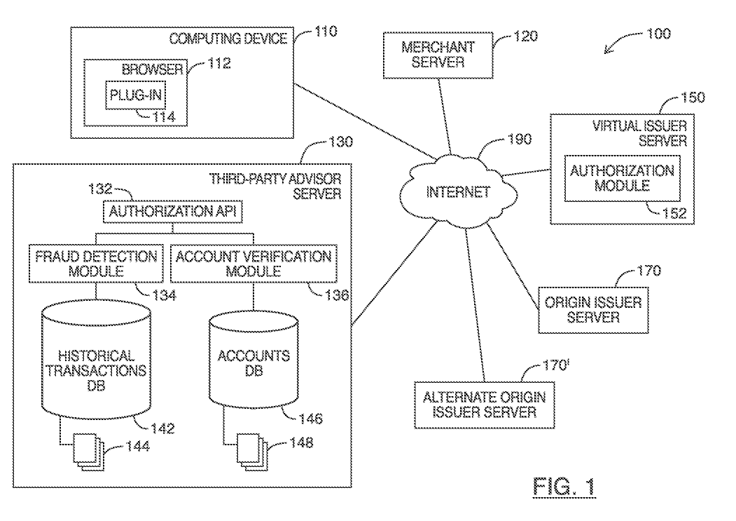

Referring to FIG. 1, shown there generally as 100 is a block diagram of a system for processing electronic payment authorization, in accordance with at least one embodiment of the present invention. The system 100 may include a computing device 110 that initiates an online payment transaction with a merchant server 120 (e.g., in an e-commerce context where the computing device 110 is being used to initiate a purchase transaction), and requests to pay using a prepaid virtual or proxy credit card. To perform payment authorization, the system 100 may also include a third-party advisor server 130, a virtual issuer server 150, and one or more origin issuer servers 170, 170′. Each of the computing device 110, merchant server device 120, third-party advisor server 130, virtual issuer server 150, and origin issuer servers 170, 170′ may be connected to a communications network such as the Internet 190 for facilitating communications.

The computing devices 110 may be various programmable computing devices (examples of which were noted above) that are configured with a suitable application for performing an online payment transaction. As illustrated, a web browser application 112 is provided, which can be used to initiate an e-commerce transaction with merchant server 120. However, in other embodiments, the electronic payment authorization for online payment transactions may be initiated with non-browser applications such as native applications (or “apps”), or an application distribution platform native to the operating system of the computing device (e.g., the Apple™ App Store™ or the Google™ Play Store™).

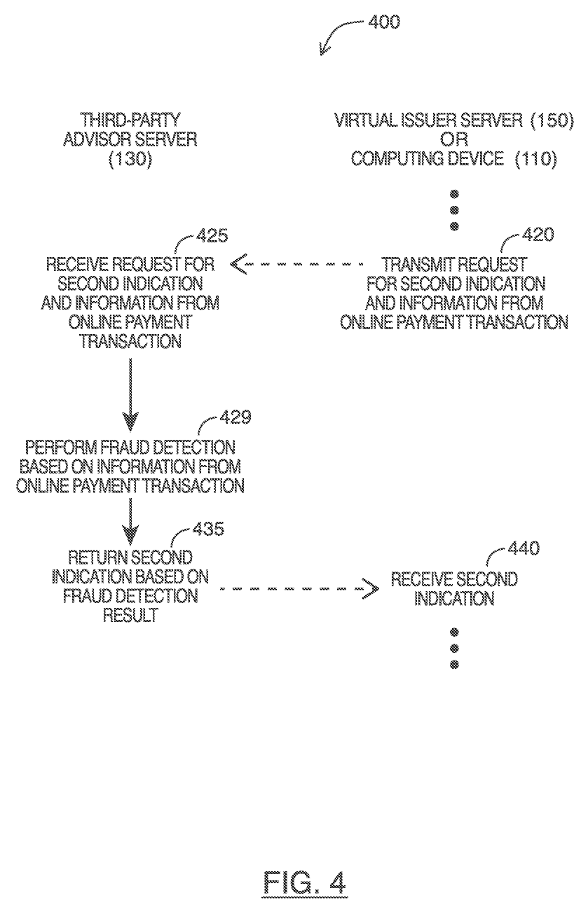

As illustrated, the browser 112 may be provided with a plug-in 114 for performing various acts described herein as being performed by the computing device 110. For example, as discussed below in the context of FIG. 4, the plug-in 114 may be configured to identify payment transaction information for the payment transaction being processed in the browser 112 and communicate that information directly to the third-party advisor server 130 so that the third-party advisor server 130 may perform fraud detection as a part of its approval process.

The plug-in 114 may be implemented using any suitable architecture of known web browsers 112 that allow for expansion of the functionality of the browser application 112. As will be understood by persons skilled in the art, plug-ins 114 may have different names in different browser architectures. For example, the term “plug-in” may be used with the browsers Google™ Chrome™ or Mozilla™ Firefox™. However, the term “add-on” may be used in the context of the Microsoft™ Internet Explorer™ browser. Further, the term “extension” may be used in the context of the Apple™ Safari™ browser. All such expansion architectures and the like may be used to implement the plug-in 114 of the embodiments described herein.

The merchant server 120 may be the destination web server with which the communication device 110 is communicating to conduct the online payment transaction. For example, the merchant server 120 may be a server providing an online e-commerce store for ordering or purchasing products. As will be understood by persons skilled in the art, the merchant server 120 may be provided with payment processing software (not shown) that identifies when a prepaid virtual or proxy credit card is used for payment and forwards the payment authorization request to a virtual issuer server 150 for processing.

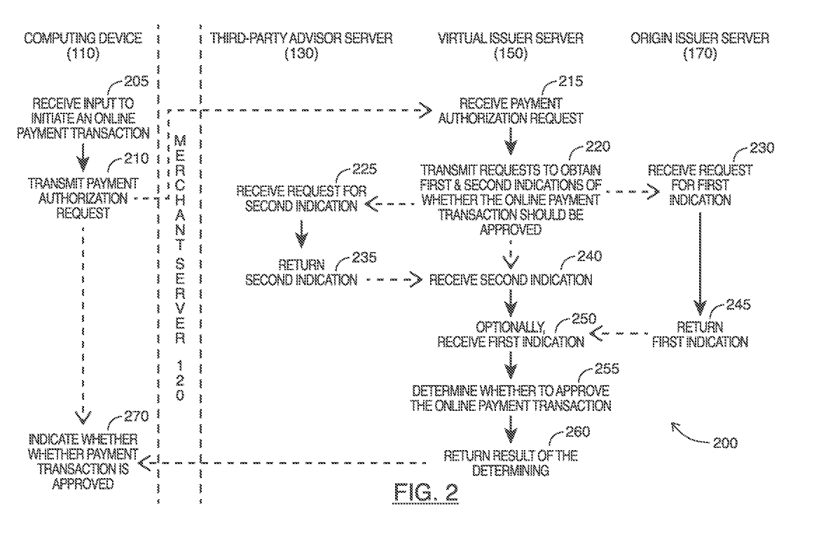

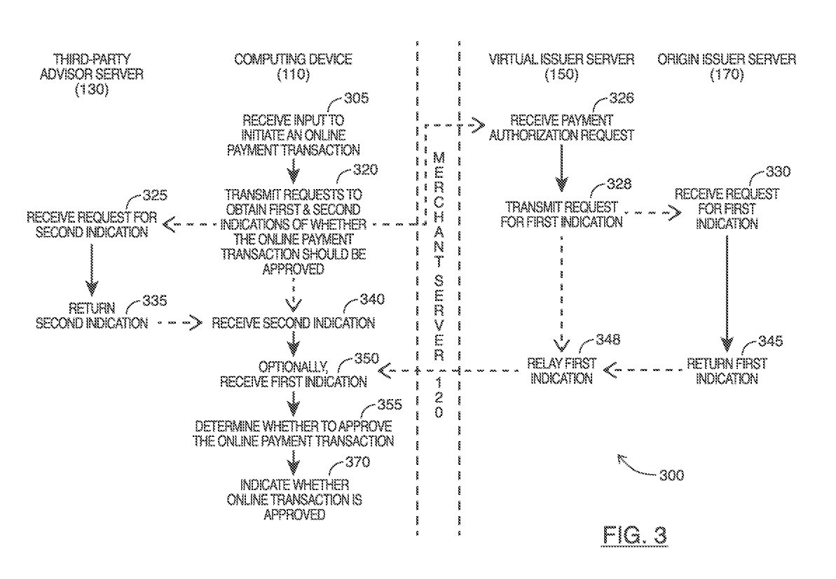

The third-party advisor server 130 may contain an authorization Application Programming Interface (API) 132 which may be accessible by either the virtual issuer server 150 or the computing device 110 during the payment authorization process. As discussed in greater detail below with respect to FIGS. 2 and 3, in the embodiments described herein, requests for indications of whether the online payment transaction initiated at the computing device 110 ought to be approved may be sent in parallel to the third-party advisor server 130 and the origin issuer server 170. Such parallel processing may provide more time for the authorization API 132 to perform additional processing that it may not otherwise have the opportunity to perform in the traditional linear message flow that requires the authorization processing of the third-party advisor server 130 and the origin issuer server 170 to be performed sequentially.

To make the determination as to whether the payment transaction should be authorized, and/or to perform such additional processing enabled by the parallel message flow, the authorization API 132 may communicate with a fraud detection module 134 and an account verification module 136.

The fraud detection module 134 is for performing fraud detection using information related to the online payment transaction to be authorized, as received by the authorization API 132 in some embodiments. In part because of the extra processing time the third-party advisor server 130 is afforded as a result of the parallel message flow, the third-party advisor server 130 may receive this information and also perform fraud detection without exceeding the time limit (e.g., five (5) seconds, as noted above, or any analogous time limit) required to approve the transaction. As discussed in greater detail below with respect to FIG. 4, in performing the fraud detection, the fraud detection module 134 may access the historical transactions database 142 storing historical transaction information 144 to compare information for a given online payment transaction to information from historical transaction payment information. Such comparisons may help to identify anomalous or unexpected transactions.

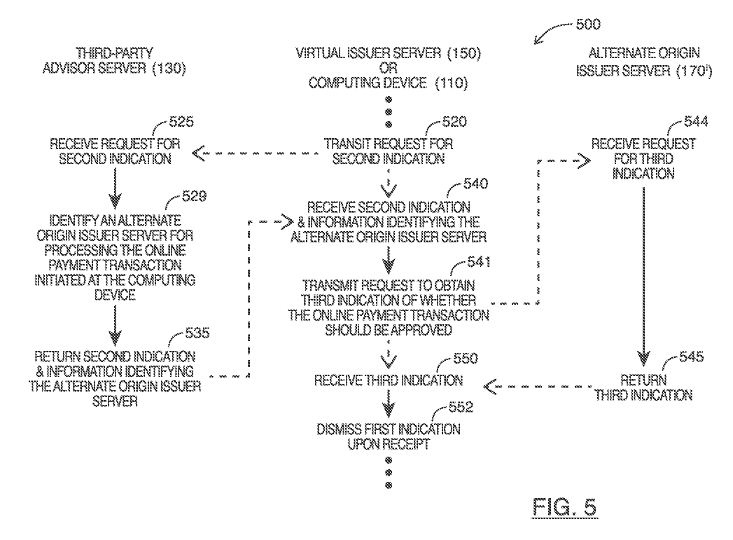

The account verification module 136 may be configured to verify that the account associated with the credit card information for which payment authorization is being requested exists, and has proper funds allocated for the transaction. To perform such checks, the account verification module 136 may access the accounts database 146 storing account information 148. As discussed in greater detail below with respect to FIG. 5, one of the additional processing steps that may be performed by the account verification module 136 includes providing the ability to use an alternate funding source to satisfy the amount of the payment being requested in the online payment transaction initiated at the computing device 110. For example, such processing steps may involve the account verification module 136 identifying information related to an alternate origin issuer server 170′ linked to the account of the virtual credit card information being used for payment, and providing that information back to computing device or server requesting the indication of whether the online payment transaction should be approved. The requesting entity may then use that information to contact the alternate origin issuer server 170′ to obtain an indication of whether data in the alternate origin issuer server 170′ indicates that there are sufficient funds for satisfying the payment request.

While the fraud detection module 134 and the account verification module 136 are illustrated and discussed herein as separate modules, it will be appreciated that in alternate embodiments, the functionality provided by the different modules may be combined together into a single module or further separated into more than the described two modules, depending on the nature of the implementation. Similarly, although the historical transactions database 142 and accounts database 146 in the third-party advisor server 130 are described and illustrated as being stored in distinct and separate databases, in alternate embodiments, the different types of data may be stored together.

The virtual issuer server 150 (e.g., the server of the bank issuing the prepaid credit card) may be configured to execute an authorization module 152 to perform the steps described as being performed by the virtual issuer server 150 herein. As discussed in greater detail below in greater detail with respect to FIG. 2, in some embodiments, the authorization module 152 itself may be configured to send parallel authorization requests to the origin issuer server 170 and the third-party advisor server 130. In other embodiments (as described in greater detail below with respect to FIG. 3), the parallel message flow may be initiated by the computing device 110 sending direct requests to the merchant server 120 and the third-party advisor server 130. In the latter embodiments, the authorization module 152 of the virtual issuer server 150 may be configured simply to relay the request/response to and from the origin issuer server 170 and the merchant server 120.

The origin issuer servers 170, 170′ may be authorization servers associated with a credit card company such as Visa™ or MasterCard™ for which the prepaid or virtual credit card has been issued. They may receive authorization requests for indications of whether the online payment transaction initiated at the computing device 110 should be approved. As will be understood by persons skilled in the art, the origin issuer servers 170, 170′ may determine if sufficient funds are available for the credit card account associated with the payment transaction requested to be authorized as a part of making its determination of whether the online payment transaction should be approved.

In various example embodiments, the third-party advisor server 130, virtual issuer server 150, and/or origin issuer servers 170, 170′ may each be implemented using one or more dedicated server computers, mainframes, computer clusters, cloud-computing service or like computing resource. In various embodiments, the components of the described servers may be implemented using a web technology stack such as LAMP (e.g., use of the Linux operating system, Apache web server, MySQL relational database management system, and the PHP programming language), or Microsoft™ technologies such as a the .NET framework, SQL Server™ database, and Internet Information Services (IIS™) web server. Various types of database technologies (e.g., MySQL, Oracle™, or IBM DB2™) may be used to provide the database(s) described herein. As will be understood by a person skilled in the art, variations in the technologies used to implement the described inventions may be possible.

Internet 190 is illustrated in FIG. 1 as an example of a communications network that may facilitate communications amongst the devices and servers shown. However, it will be understood that other communications networks may also be possible. For example, the communication of messages described in the current disclosure may be performed (either wholly or partially) through proprietary or private networks, or cellular networks.

### Virtual Issuer Server Transmitting Parallel Requests to the Third-party Advisor Server and Origin Issuer Server

Referring to FIG. 2, shown there generally as 200 is a flowchart diagram illustrating steps performed during a method of processing electronic payment authorization in which the virtual issuer server 150 sends a request for authorization advice to a third-party advisor server 130 in parallel with an authorization request to the origin issuer server 170, in accordance with at least one embodiment of the present invention. In discussing the method of FIG. 2, reference will simultaneously be made to the components of FIG. 1. As illustrated, FIG. 2 shows the interactions amongst the computing device 110, third-party advisor server 130, virtual issuer server 150 and the origin issuer server 170. In some embodiments, the steps described as being performed by the computing device 110 may be performed by a processor provided on the computing device 110, executing the plug-in 114 installed for use with browser application 112. Similarly, the steps described as being performed by the third-party advisor server 130 may be performed by a processor provided on the third-party advisor server 130, executing the authorization API 132 and/or account verification module 136. Further, the steps described as being performed by the virtual issuer server 150 may be performed by a processor provided on the virtual issuer server 150, executing the authorization module 152.

At step 205, the computing device 110 may receive input to initiate an online payment transaction. As noted above, a user of the computing device 110 may attempt to initiate an online payment transaction by using the browser application 112 installed on the computing device 110 to access the merchant server 120 (e.g., the web server of an e-commerce retailer).

At step 210, the computing device 110 may transmit a payment authorization request for the online payment transaction from the computing device 110 to a merchant server 120, and the merchant server 120 may transmit a corresponding authorization request to a virtual issuer server 150. For simplicity of illustration, the active steps performed by the merchant server 120 are not shown in FIG. 2, and the merchant server 120 is simply shown as a conduit through which the payment authorization request may travel from the computing device 110 to the virtual issuer server 150. However, it will be understood by persons skilled in the art that normal payment authorization steps typically performed by payment processing software executing on merchant server 120 may be performed in the embodiments described herein. At step 215, the payment authorization request is received at virtual issuer server 150.

At step 220, upon receiving the authorization request from the merchant server 120, the virtual issuer server 150 may transmit requests to obtain first and second indications of whether the online payment transaction should be approved. This step may involve the virtual issuer server 150 transmitting a request to an origin issuer server 170 to obtain a first indication of whether the online payment transaction initiated at the computing device 110 should be approved, and the virtual issuer server 150 transmitting a request to a third-party advisor server 130 to obtain a second indication of whether the online payment transaction initiated at the computing device 110 should be approved. As shown in step 220 of FIG. 2, the request to the third-party advisor server 130 may be transmitted in parallel with the request to the origin issuer server 170 and prior to a response being received from the origin issuer server 170 for the request for the first indication.

As noted above, the virtual issuer server 150 is under a constraint by which it is to respond to the merchant server 120 with an approval or denial message within a time constraint (e.g., five (5) seconds). In a linear message flow, the third-party advisor server 130 is required to provide a quick response to the virtual issuer server 150, so as to take up as little of this time window as possible. This is because the virtual issuer server 150 may still need to contact the origin issuer server 170 (which may itself take up to five (5) seconds to respond) and obtain a response from it before returning an approval or denial message to the merchant server 120.

Unlike systems in which there is a linear message flow, the parallel message flow described herein may allow the authorization processing performed by the third-party advisor server 130 and the origin issuer server 170 to proceed simultaneously. In this manner, the third-party advisor server 130 may be provided with additional time to perform processing that it would not have in the linear message flow arrangement. This is because the third-party advisor server 130 is freed from the limitations that require it to provide a quick response so that the origin issuer server 170 may perform its authorization process. In effect, the third-party advisor server 130 may consume more of the time window allotted to the virtual issuer server 150 for responding to the merchant server 120, without causing the virtual issuer server 150 to fail to respond within its allotted timeframe.

As used herein, the term “indication” may refer to any information or data that may be provided in response to an authorization request. For example, in some embodiments, it may include an approval or denial message of whether the online payment transaction initiated at the computing device 110 should be approved.

At step 225, the third-party advisor server 130 may receive the request for the second indication from the virtual issuer server 150. At step 230, the origin issuer server 170 may receive the request for the first indication from the virtual issuer server 150. Although step 225 is provided with a reference numeral in FIG. 2 that is lower than step 230, it will be understood by persons skilled in the art that the receipt of the request for the first indication and the request for the second indication may be performed in any order.

Upon receiving the requests for the first and second indications, each of the third-party advisor server 130 and the origin issuer server 170 may perform their respective steps (not shown in FIG. 2) for making a determination of whether the online payment transaction initiated at step 205 should be approved. As discussed in greater detail below with respect to FIGS. 4 and 5, with the extra processing time afforded to the third-party advisor server 130 as a result of the parallel message flow of the embodiments described herein, these steps may include performing fraud detection or providing information for locating an alternate origin issuer server 170′.

After performing the steps for making a determination, the third-party advisor server 130 may generate the second indication of whether the online payment transaction initiated at step 205 should be approved.

At step 235, the third-party advisor server 130 may return the second indication to the virtual issuer server 150. At step 240, the virtual issuer server 150 may receive, from the third-party advisor server 130, the second indication of whether the online payment transaction initiated at the computing device 110 should be approved.

The origin issuer server 170 may itself perform processing to determine whether the online payment transaction initiated at step 205 should be approved. At step 245, the origin issuer server 170 may return the first indication to the virtual issuer server 150. At step 250, the virtual issuer server 150 may receive the first indication from the origin issuer server 170.

At step 255, the virtual issuer server 150 may determine, based on one or more of the first indication and the second indication, whether to approve the online payment transaction initiated at the computing device 110. Generally, if any one of the first indication or the second indication contains information indicating that the online payment transaction should not be approved, then the virtual issuer server 150 will determine that the online payment transaction initiated at the computing device 110 should be denied.

In some embodiments, the virtual issuer server 150 may perform the determination of step 255 based solely on the first indication alone or based solely on the second indication alone. For example, this may occur if either of the first indication or the second indication is received at the virtual issuer server 150 prior to the other and such earlier-received indication contains information indicating that the online payment transaction should not be approved, then the virtual issuer server 150 may immediately determine that the transaction should be denied and proceed to step 260. As illustrated in FIG. 2, an embodiment is shown in which the second indication is received at the virtual issuer server 150 prior to first indication. Step 250 is then shown as being an optional step because the virtual issuer server 150 may proceed to step 255 without the first indication having been received at the virtual issuer server 170. In such case, the determining performed at step 255 may be performed on the sole basis of the second indication, prior to the first indication being received from the origin issuer server 170.

In some embodiments, step 250 may be optional (e.g., the method may proceed to the determining step 255 without the first indication having been received) regardless of the order in which the first indication and second indication are received at the virtual issuer server 150. As discussed in greater detail below with respect to FIG. 5, this may occur if information for identifying an alternate origin issuer server 170′ accompanies the second indication from the third-party advisor server 130. In such case, the virtual issuer server 150 may be configured to request and rely on a third indication of whether the online payment transaction should be approved (as received from the alternate origin issuer server 170′) instead of the first indication received from the origin issuer server 170.

At step 260, the virtual issuer server 150 may return a result of the determining performed at step 255 to the merchant server 120 in response to the corresponding authorization request transmitted from the merchant server 120 to the virtual issuer server 150. Upon receipt at the merchant server 120, the result of the determining is relayed to the computing device 110 in response to the payment authorization request transmitted from the computing device 110 to the merchant server 120 at step 210.

At step 270, the computing device 110 may indicate whether the online payment transaction initiated at step 205 is approved, based on the result received from the virtual issuer server 150 at step 260. For example, this may involve the computing device 110 updating the user interface of the browser application 112 executing thereon to reflect whether the requested transaction is allowed to proceed.

### Computing Device Transmitting Parallel Requests to the Third-Party Advisor Server and Merchant Server

Referring to FIG. 3, shown there generally as 300 is a flowchart diagram illustrating steps performed during a method of processing electronic payment authorization in which the client computing device 110 sends a request for authorization advice to a third-party advisor server 150 in parallel with an authorization request to a merchant server 120, in accordance with at least one embodiment of the present invention. The embodiment shown in FIG. 3 is similar to the one shown in FIG. 2, except that the parallel authorization requests are initiated directly from the computing device 110 instead of from the virtual issuer server 150. In discussing the method of FIG. 3, reference will simultaneously be made to the components of FIG. 1. FIG. 3 shows the interactions amongst the computing device 110, third-party advisor server 130, virtual issuer server 150 and the origin issuer server 170. Similar to FIG. 2, in some embodiments, the steps described as being performed by the computing device 110 may be performed by a processor provided on the computing device 110, executing the plug-in 114 for browser 112. The steps described as being performed by the third-party advisor server 130 may be performed by a processor provided on the third-party advisor server 130, executing the authorization API 132 and/or account verification module 136. Also, the steps described as being performed by the virtual issuer server 150 may be performed by a processor provided on the virtual issuer server 150, executing the authorization module 152.

At step 305, the computing device 110 may receive input at a computing device 110 to initiate an online payment transaction. This step may be performed in a similar manner to what was discussed above for step 205 to FIG. 2.

At step 320, the computing device 110 may transmit a payment authorization request for the online payment transaction to a merchant server 120. This request may be analogous to the authorization request transmitted at step 210 of FIG. 2. However, in the embodiment of FIG. 3, the request may be considered a request for a first indication of whether the online payment transaction initiated at the computing device 110 should be approved being transmitted to the origin issuer server 170 (as relayed through the merchant server 120 and the virtual issuer server 150).

In parallel with the request sent to the merchant server 120, step 320 may also involve the computing device 110 transmitting a request to a third-party advisor server 130 to obtain a second indication of whether the online payment transaction initiated at the computing device 110 should be approved. In embodiments where the online payment transaction is initiated using the browser application 112 executing on the computing device 110, the transmitting of the request to the third-party advisor server 130 may be performed by the plug-in 114 installed for execution with the browser application 112. As with the parallel requests sent by the virtual issuer server 150 at step 220 in FIG. 2, the request for the second indication may be sent by the computing device 110 prior to a response for the first indication being received from the merchant server 120 (the first indication originating from origin issuer server 170 and being relayed through the virtual issuer server 150).

At step 325, the third-party advisor server 130 may receive the request for the second indication from the computing device 110. At step 335, the third-party advisor server 130 may return the second indication to the computing device 110. The second indication may then be received at the computing device 110 at step 340. Steps 325, 335, and 340 in FIG. 3 may be performed in a manner similar to steps 225, 235, and 240 discussed above with respect to FIG. 2, except that instead of the third-party advisor server 130 returning the second indication to the virtual issuer server 150, the third-party advisor server 130 returns the second indication directly to the computing device 110.

Upon receiving the request for a first indication from the computing device 110, the merchant server 120 may transmit a corresponding authorization request to a virtual issuer server 150. This request may be received at the virtual issuer server 150 at step 326. For simplicity of illustration, the active steps performed by the merchant server 120 are not shown in FIG. 3. However, as with the method illustrated in FIG. 2, it will be understood by persons skilled in the art that normal payment authorization steps typically performed by payment processing software executing on merchant server 120 may be performed.

At step 328, upon receiving the corresponding authorization request, the virtual issuer server 150 may transmit a request to an origin issuer server 170 to obtain a first indication of whether the online payment transaction initiated at the computing device 110 should be approved. At step 330, the origin issuer server 170 may receive the request to obtain the first indication from the virtual issuer server 150. At step 345, the origin issuer server 170 may then return the first indication to the virtual issuer server 150. Steps 330 and 345 may be performed in a manner similar to steps 230 and 245 of FIG. 2 discussed above.

The virtual issuer server 150 may receive the first indication from the origin issuer server 170. At step 348, the first indication may then be relayed back to the computing device 110 from the virtual issuer server 150 server via the merchant server 120. The relaying back of the first indication to the computing device 110 may be performed in response to the payment authorization request initially transmitted from the computing device 110 to the merchant server 120 at step 320. At step 350, the computing device 110 may receive the first indication from the merchant server 120.

At step 355, the computing device 110 may determine, based on one or more of the first indication and the second indication, whether to approve the online payment transaction initiated at the computing device 110 in step 305. This step may be performed in a manner similar to the analogous step 255 being performed by the virtual issuer server 150 in the method illustrated in FIG. 2 (e.g., the computing device 110 may perform the determination of step 355 based solely on the first indication alone or based solely on the second indication alone). Similar with step 250 in FIG. 2, step 350 in FIG. 3 is accordingly shown as being an optional step because it may not be performed in certain embodiments.

At step 370, the computing device 110 may indicate whether the online payment transaction initiated at step 305 is approved. Step 370 may be performed in a manner similar to step 270 of the method of FIG. 2.

### Third-Party Advisor Server Performing Fraud Detection

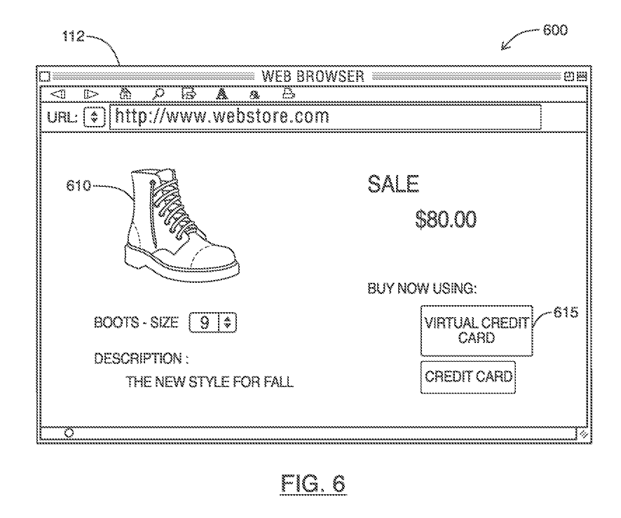

Referring to FIG. 4, shown there generally as 400 is a flowchart diagram illustrating steps performed by a third-party advisor server 130 to detect fraud during a method of processing electronic payment authorization, in accordance with at least one embodiment of the present invention. In discussing the method of FIG. 4, reference will simultaneously be made to the components of FIG. 1, the methods shown in FIGS. 2 and 3, and the example user interface shown in FIG. 6.

As noted above with respect to FIGS. 2 and 3, the parallel message flow of the embodiments of the present disclosure may allow the third-party advisor additional processing time that it might not otherwise have with a linear message flow. FIG. 4 illustrates one example where the additional processing is used for performing fraud detection. As illustrated, FIG. 4 shows certain interactions between the third-party advisor server 130 and the device or server from which the parallel authorization requests messages are initiated from (e.g., the virtual issuer server 150 in the method of FIG. 2 or the computing device 110 in the method of FIG. 3), as they relate to the second indication. In this manner, depending on the context, steps 420 to 440 of FIG. 4 may be performed in place of (or in addition to) corresponding steps related to the second indication in the methods of FIGS. 2 and 3 (e.g., steps 220, 225, 235, and 240 of FIG. 2, and steps 320, 325, 335, and 340 of FIG. 3).

At step 420, the virtual issuer server 150 or the computing device 110 (as the case may be) may transmit a request for a second indication of whether an online payment transaction initiated at the computing device 110 should be approved. In various embodiments, step 420 of FIG. 4 may be considered as being performed in place of step 220 of FIG. 2 or step 320 of FIG. 3. However, in the method of FIG. 4, the request for the second indication is accompanied by information from the online payment transaction for which approval is being requested.

The online payment transaction may be captured in various ways, prior to step 420 of FIG. 4 being performed. For example, in the case where the online payment transaction is initiated by a browser application 112 on computing device 110, a plug-in 114 installed for execution by browser application 112 may be configured to recognize when a payment form or a screen for making an online payment transaction is being displayed in the browser application 112. Once the payment form is recognized, the plug-in 114 may be configured to display a prompt requesting user input to confirm that payment using a secure virtual credit card is desired. If input selecting the prompt is received at the computing device 110, the plug-in 114 may record the information entered for the online payment transaction. The information may then be transmitted to the virtual issuer server 150 via the merchant server 120, so that it may be further transmitted to the third-party advisor server 130 therefrom (if in the context of the method of FIG. 2) or be processed so that it may be transmitted directly to the third-party advisor server 130 (if in the context of the method of FIG. 3).

Referring briefly simultaneously to FIG. 6, shown there generally as 600 is an example user interface showing a web browser application 112 providing a user interface control for selecting payment using a virtual credit card, in accordance with at least one embodiment of the present invention. For example, a plug-in 114 installed on the browser 112 may detect that a screen for making an online payment transaction is displayed (e.g., an example is shown where a pair of boots 610 is available for sale). The plug-in 114 may then be configured to present an option 615 that may be selected if the user desires to pay using a secure virtual credit card. Upon selection, the plug-in may subsequently record the information related to the online payment transaction for transmittal, as noted above.

Referring back to FIG. 4, in various embodiments, the information from the online payment transaction transmitted to the third-party advisor server 130 may include different types of information. For example, the information may include a Uniform Resource Locator (URL) of the merchant server 120, an Internet Protocol (IP) address of the merchant server 120, an IP address of the computing device 110, personal information (e.g., of a user of the computing device 110, of a credit card holder, and/or of a gift recipient) recorded for the transaction, and/or details about the credit card used in the online payment transaction.

At step 425, the third-party advisor server 130 may receive the request for the second indication and the information from the online payment transaction. In various embodiments, step 425 of FIG. 4 may be considered as being performed in place of step 225 of FIG. 2 or step 325 of FIG. 3.

At step 429, the third-party advisor server 130 may perform fraud detection based on the information from the online payment transaction, as received at step 425. For example, as noted above, this step may involve a comparison of the information about the online payment transaction against historical transaction made by this purchaser. The comparison may help to identify anomalous or unexpected transactions that are atypical for the holder of the credit card account. Such fraud detection steps may be performed by the fraud detection module 134 of the third-party advisor server 130 accessing the historical transaction information 144 stored in historical transactions database 142 (as shown in FIG. 1).

In various embodiments, anomalous transactions may be identified if the geographical location of the computing device 110 or the merchant server 120 is unexpected. For example, a geographical location of the computing device 110 may be unexpected for the credit card holder if the computing device 110 where the transaction originated is in a location that is atypical for the credit card holder (e.g., the transaction originated in a country in Africa, when the credit card has never been used in Africa and the cardholder's billing address is in North America). In another example, the geographical location of the computing device 110 or the merchant server 120 may be unexpected if a determined geographical location of either entity is known to be associated with a country that is involved with many fraudulent transactions or would not likely be associated with a legitimate transaction (e.g., North Korea).

The geographical location information may be identified in various ways using the information from the online payment transaction. For example, the geographical location of the computing device 110 or the merchant server 120 may be identified from their respective IP addresses. Additionally or alternatively, the geographical location of the computing device 110 may be approximated from a billing or shipping address included in the personal information recorded for the online payment transaction.

The third-party advisor server 130 may then use the result of the fraud detection steps to make a determination as to whether the online payment transaction initiated at step 205 of FIG. 2 or step 305 of FIG. 3 (as the case may be) should be approved, and generate the second indication.

At step 435, the third-party advisor server 130 may then return the second indication of whether the online payment transaction initiated at the computing device 110 should be approved. The second indication may then be received at step 440. In various embodiments, step 435 and 440 of FIG. 4 may be considered as being performed in place of step 235 and 240 of FIG. 2, or step 325 and 340 of FIG. 3. As a result, the second indication may be returned to the virtual issuer server 150 (if performed in the context of the method of FIG. 2) or the computing device 110 (if performed in the context of the method of FIG. 3).

After step 440, the methods may be continued as was discussed above, after the second indication has been received (e.g., after step 240 in FIG. 2 and step 340 in FIG. 3).

### Third-party Advisor Server Providing Information Identifying an Alternate Origin Issuer Server

Referring to FIG. 5, shown there generally as 500 is a flowchart diagram illustrating steps performed during a method of processing electronic payment authorization in which the third-party advisor server 130 identifies an alternate origin issuer server 170′ for processing the online payment transaction, in accordance with at least one embodiment of the present invention. In discussing the method of FIG. 5, reference will simultaneously be made to the components of FIG. 1, and the methods shown in FIGS. 2 and 3.

As noted above, another example of the additional processing that can be performed by the third-party advisor server 130 as a result of the present disclosure's parallel message flow is that it may identify an alternate origin issuer server 170′ that can be used instead of the original origin issuer server 170 to satisfy payment of the pending online payment transaction. As with FIG. 4, FIG. 5 shows certain interactions between the third-party advisor server 130 and the device or server from which the parallel authorization requests messages are initiated from (e.g., the virtual issuer server 150 if in the method of FIG. 2 or the computing device 110 if in the method of FIG. 3), as they relate to the second indication. In this manner, in various embodiments, steps 520, 525, 529, 535, and 540 of FIG. 5 may similarly be performed in place of steps 220, 225, 235, and 240 of FIG. 2 or steps 320, 325, 335, and 340 of FIG. 3. Moreover, in some embodiments, the steps 420, 425, 429, 435, and 440 of FIG. 4 may be performed in conjunction with steps 520, 525, 529, 535, and 540 of FIG. 5, such that the third-party advisor server 130 is configured to perform both fraud detection and provide information identifying an alternate origin issuer server 170′.

At step 520, the virtual issuer server 150 or computing device 110 (as the case may be) may transmit a request to a third-party advisor server 130 to obtain a second indication of whether the online payment transaction initiated at the computing device 110 should be approved. The request may be received at the third-party advisor server at step 525. In various embodiments, steps 520 and 525 of FIG. 5 may be considered to be analogous to steps 220 and 225 of FIG. 2, or steps 320 and 325 of FIG. 3. As such, the discussion above with respect to such steps is applicable to FIG. 5 also.

However, in the embodiment of FIG. 5, prior to step 520, the computing device 110 may be configured to present an option to allow users to select different funding sources linked to the virtual credit card to be used for payment of the online payment transaction. If selected, the request for the second indication transmitted at step 520 may include a notification to the third-party advisor server 130 that information identifying an alternate origin issuer server 170′ is requested.

At step 529, the third-party advisor server 130 may identify an alternate origin issuer server 170′ for processing the online payment transaction initiated at the computing device 110. For example, this may involve the account verification module 136 searching accounts database 146 storing account information 148 (as shown in FIG. 1) to identify information related to an alternate origin issuer server 170′ linked to the account of the virtual credit card being used for payment. As will be understood by persons skilled in the art, in various embodiments, the account of the virtual credit card being used for payment may be linked to multiple funding sources (each associated with different origin issuer servers 170, 170′) that may satisfy payment for a requested transaction. In such embodiments, the third-party advisor server 130 may be configured to identify an alternate origin issuer server 170′ from such information identifying origin issuer servers associated with the multiple funding sources.

At step 535, the third-party advisor server 130 may return the second indication and information identifying the alternate origin issuer server 170′ to the virtual issuer server 150 (in the case of the method of FIG. 2) or the computing device 110 (in the case of the method of FIG. 3). The second indication and the information identifying the alternate origin issuer server 170′ may be received at step 540. Steps 535 and 540 of FIG. 5 are analogous to the corresponding steps for receiving the second indication at steps 235 and 240 of FIG. 2, and 340 and 340 of FIG. 3; except that information for identifying the alternate origin issuer server 170′ for processing the online payment transaction initiated at the computing device 110 is also provided.

At step 541, the virtual issuer server 150 or the computing device 110 (as the case may be) may transmit a request to the alternate origin issuer server 170′ identified by the information received at step 540 to obtain a third indication of whether the online payment transaction initiated at the computing device 110 should be approved. This request may be received at the alternate origin issuer server 170′ at step 544.

At step 545, the alternate origin issuer server 170′ may return the third indication to the virtual issuer server 150 or the computing device 110 (as the case may be). The third indication may be received at step 550.

If the third indication is requested from the virtual issuer server 150, then steps 541, 544, 545, and 550 of FIG. 5 may be performed in a manner similar to steps 220, 230, 245, and 250 of FIG. 2. However, if the third indication is being requested from the computing device 110, then steps 541, 544, 545, and 550 of FIG. 5 may be performed in a manner that is similar to steps 320, 326, 328, 330, 345, 348, and 350 of FIG. 3. That is, for ease of illustration, the steps of FIG. 5 show the computing device 110 communicating directly with the alternate origin issuer server 170. However, the message flow may in fact be processed through the merchant server 120 and virtual issuer server 150 in the manner that is shown in FIG. 3. Further, as was the case for the request for the first indication transmitted from the computing device 110 in FIG. 3, the transmission of an authorization request to the merchant server 120 that is destined for the alternate origin issuer server 170′ may be considered a request for a third indication.

Upon receiving the third indication, the virtual issuer server 150 or the computing device 110 (as the case may be) may proceed to make the determination of whether to approve the online payment transaction initiated the computing device 110 (e.g., steps 255 of FIG. 2 or 355 of FIG. 3) based in part on the third indication received from the alternate origin issuer server 170′.

Referring still to FIG. 5, in some embodiments, step 552 may be performed prior to proceeding to the determining step. At step 552, the virtual issuer server 150 or the computing device 110 (as the case may be) may dismiss the first indication (when it is received from the original origin issuer server 170) so that it is not taken into account when performing the step of determining whether to approve the online payment transaction initiated at the computing device 110. This may occur if, for example, the computing device 110 was not configured to present a user interface presenting an option to select to use a secondary source of funding (e.g., as noted above, such an interface may have been presented prior to step 520). Instead, the third-party advisor server 130 may have been pre-configured (e.g., through a separate web interface for configuring the virtual credit card account) to use the secondary source of funding in lieu of a primary source of funding normally associated with the virtual credit card account. In such case, in steps prior to or simultaneously with step 520 of FIG. 5 (e.g., as part of steps 220 in FIG. 2 or step 320 in FIG. 3), a request for a first indication may have already been transmitted to the original origin issuer server 170. But since the response to the request for the second indication received at step 540 indicated that an alternate origin issuer server 170′ is to be used instead, the virtual issuer server 150 or the computing device 110 (as the case may be) may proceed to use the third indication in determining whether the online payment transaction initiated at the computing device 110 should be approved. The first indication may thus be dismissed when it is received, since it is no longer relevant for performing the determining step.

All publications and patent applications mentioned in this specification are herein incorporated by reference to the same extent as if each individual publication or patent application was specifically and individually incorporated by reference.

While the foregoing disclosure has been described in some detail for purposes of clarity and understanding, such disclosure is provided by way of example only. It will be appreciated by one skilled in the art, from a reading of the disclosure that various changes in form and detail of these exemplary embodiments can be made without departing from the true scope of the disclosure, which is limited only by the appended claims. For example, it should be understood that acts and the order of the acts performed in the processing described herein may be altered, modified and/or augmented (whether or not such steps are described in the claims, figures or otherwise in any sequential numbered or lettered manner) yet still achieve the desired outcome. While processes or blocks are presented in a given order, alternative examples may perform routines having steps, or employ systems having blocks, in a different order, and some processes or blocks may be deleted, moved, added, subdivided, combined, and/or modified to provide alternatives or subcombinations. Each of these processes or blocks may be implemented in a variety of different ways. Also, while processes or blocks are at times shown as being performed in series, these processes or blocks may instead be performed in parallel, or may be performed at different times.

In the various user interfaces illustrated in the figures, it will be understood that the illustrated user interface text and controls are provided as examples only and are not meant to be limiting with regards to their appearance. Other suitable ways of arranging and modifying the appearance of user interface elements may be possible.

Those skilled in the relevant art will appreciate that aspects of the system can be practised with other communications, data processing, or computer system configurations, including: Internet appliances, cloud computing, multi-processor systems, microprocessor-based or programmable devices, network PCs, mini-computers, mainframe computers, and the like.

Software and other modules may be accessible via local memory, via a network, via a browser or other application in an Application Service Provider (ASP) context, or via other means suitable for the purposes described herein. Examples of the technology can also be practised in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices. Data structures (e.g., containers) described herein may comprise computer files, variables, programming arrays, programming structures, or any electronic information storage schemes or methods, or any combinations thereof, suitable for the purposes described herein.

Where a component (e.g. a model, processor, scheduler, display, data store, software module, assembly, device, circuit, etc.) is referred to above, unless otherwise indicated, reference to that component should be interpreted as including as equivalents of that component any component which performs the function of the described component (i.e., that is functionally equivalent), including components which are not structurally equivalent to the disclosed structure which performs the function in the illustrated exemplary embodiments of the invention.

As used herein, the wording “and/or” is intended to represent an inclusive-or. That is, “X and/or Y” is intended to mean X or Y or both. Moreover, “X, Y, and/or Z” is intended to mean X or Y or Z or any combination thereof.

What is claimed is:

1. A method of processing electronic payment authorization, the method comprising:
receiving input at a computing device to initiate an online payment transaction;
transmitting a payment authorization request for the online payment transaction from the computing device to a merchant server, wherein the merchant server transmits a corresponding authorization request to a virtual issuer server, and upon receiving the corresponding authorization request, the virtual issuer server transmits a request to an origin issuer server to obtain a first indication of whether the online payment transaction initiated at the computing device should be approved;
transmitting a request to a third-party advisor server to obtain a second indication of whether the online payment transaction initiated at the computing device should be approved, wherein the request to the third-party advisor server is transmitted in parallel with the transmitting of the request to the origin issuer server and prior to a response being received from the origin issuer server;
determining, based on one or more of the first indication and the second indication, whether to approve the online payment transaction initiated at the computing device; and
indicating at the computing device whether the online payment transaction is approved.

2. The method of claim 1, wherein the transmitting of the request to the third-party advisor server is performed at the virtual issuer server, and the virtual issuer server receives the first indication and the second indication from the origin issuer server and the third-party advisor server respectively.

3. The method of claim 2, wherein the determining whether to approve the online payment transaction is performed at the virtual issuer server, and a result of the determining is provided to the merchant server in response to the corresponding authorization request transmitted from the merchant server to the virtual issuer server.

4. The method of claim 3, wherein upon receipt at the merchant server, the result of the determining is relayed to the computing device in response to the payment authorization request transmitted from the computing device to the merchant server.

5. The method of claim 1, wherein the transmitting of the request to the third-party advisor server is performed at the computing device, and the computing device receives the second indication from the third-party advisor server.

6. The method of claim 5, wherein the online payment transaction is initiated using a browser application executing on the computing device, and wherein the transmitting of the request to the third-party advisor server is performed by a plug-in installed for execution with the browser application.

7. The method of claim 5, wherein the virtual issuer server receives the first indication from the origin issuer server, and in response to the payment authorization request transmitted from the computing device to the merchant server, the first indication is relayed back to the computing device from the virtual issuer server via the merchant server.

8. The method of claim 5, wherein the determining whether to approve the online payment transaction is performed at the computing device.

9. The method of claim 1, wherein the request transmitted to the third-party advisor server comprises information from the online payment transaction.

10. The method of claim 9, wherein the information from the online payment transaction comprises one or more of the following: a Uniform Resource Locator (URL) of the merchant server, an Internet Protocol (IP) address of the merchant server, an IP address of the computing device, personal information recorded for the transaction, and details about the credit card used in the online payment transaction.

11. The method of claim 1, further comprising:
receiving, from the third-party advisor server, the second indication of whether the online payment transaction initiated at the computing device should be approved;
wherein the determining whether to approve the online payment transaction initiated at the computing device is performed on the sole basis of the second indication, prior to the first indication being received from the origin issuer server.

12. The method of claim 1, further comprising:
in response to the request transmitted to the third-party advisor server, receiving information identifying an alternate origin issuer server for processing the online payment transaction initiated at the computing device; and
transmitting a request to the alternate origin issuer server to obtain a third indication of whether the online payment transaction initiated at the computing device should be approved;
wherein, the determining whether to approve the online payment transaction initiated at the computing device is performed based in part on the third indication received from the alternate origin issuer server.

13. The method of claim 12, further comprising:
receiving, from the origin issuer server, the first indication of whether the online payment transaction initiated at the computing device should be approved; and
dismissing the first indication when performing the determining whether to approve the online payment transaction initiated at the computing device.

14. A server for processing electronic payment authorization, the server comprising a processor and a memory for storing instructions which, when executed by the processor, cause the processor to:
receive an authorization request from a merchant server, the authorization request corresponding to a payment authorization request transmitted from a computing device when the computing device received input to initiate an online payment transaction;
upon receipt of the authorization request, transmit a request to an origin issuer server to obtain a first indication of whether the online payment transaction initiated at the computing device should be approved;
transmit a request to a third-party advisor server to obtain a second indication of whether the online payment transaction initiated at the computing device should be approved, wherein the request to the third-party advisor server is transmitted in parallel with the transmitting of the request to the origin issuer server and prior to a response being received from the origin issuer server; and
receive the first indication and the second indication from the origin issuer server and the third-party advisor server respectively.

15. The server of claim 14, wherein the processor is further configured to:
based on one or more of the first indication and the second indication, determine whether to approve the online payment transaction initiated at the computing device; and
provide a result of the determining to the merchant server, in response to the receipt of the authorization request from the merchant server.

16. The server of claim 15, wherein upon receipt at the merchant server, the result of the determining is relayed to the computing device in response to the payment authorization request being transmitted from the computing device when the computing device received input to initiate the online payment transaction.

17. The server of claim 14, wherein the request transmitted to the third-party advisor server comprises information from the online payment transaction.

18. The server of claim 17, wherein the information from the online payment transaction comprises one or more of the following: a Uniform Resource Locator (URL) of the merchant server, an Internet Protocol (IP) address of the merchant server, an IP address of the computing device, personal information recorded for the transaction, and details about the credit card used in the online payment transaction.

19. The server of claim 15, wherein the processor is further configured to perform the determining of whether to approve the online payment transaction initiated at the computing device on the sole basis of the second indication, prior to the first indication being received from the origin issuer server.

20. The server of claim 15, wherein the processor is further configured to:
in response to the request transmitted to the third-party advisor server, receive information identifying an alternate origin issuer server for processing the online payment transaction initiated at the computing device; and
transmit a request to the alternate origin issuer server to obtain a third indication of whether the online payment transaction initiated at the computing device should be approved;
wherein, the determining whether to approve the online payment transaction initiated at the computing device is performed based in part on the third indication received from the alternate origin issuer server.

21. The server of claim 20, wherein the processor is further configured to:
dismiss the first indication when performing the determining whether to approve the online payment transaction initiated at the computing device.

22. A computing device comprising a processor and a memory for storing instructions which, when executed by the processor, cause the processor to:
receive input to initiate an online payment transaction;
transmit a payment authorization request for the online payment transaction to a merchant server, wherein the merchant server transmits a corresponding authorization request to a virtual issuer server, and upon receiving the corresponding authorization request, the virtual issuer server transmits a request to an origin issuer server to obtain a first indication of whether the online payment transaction initiated at the computing device should be approved;
transmit a request to a third-party advisor server to obtain a second indication of whether the online payment transaction initiated at the computing device should be approved, wherein the request to the third-party advisor server is transmitted in parallel with the transmitting of the request to the merchant server and prior to a response being received from the merchant server;
receive the second indication from the third-party advisor server;
determine, based on one or more of the first indication and the second indication, whether to approve the online payment transaction initiated at the computing device; and
indicate at the computing device whether the online payment transaction is approved.

23. The computing device of claim 22, wherein the online payment transaction is initiated using a browser application executing on the computing device, and wherein the transmitting of the request to the third-party advisor server is performed by a plug-in installed for execution with the browser application.

24. The computing device of claim 22, wherein the virtual issuer server receives the first indication from the origin issuer server, and in response to the payment authorization request transmitted from the computing device to the merchant server, the processor is further configured to:
receive the first indication from the merchant server, as relayed from the virtual issuer server.

25. The computing device of claim 22, wherein the request transmitted to the third-party advisor server comprises information from the online payment transaction.

26. The computing device of claim 25, wherein the information from the online payment transaction comprises one or more of the following: a Uniform Resource Locator (URL) of the merchant server, an Internet Protocol (IP) address of the merchant server, an IP address of the computing device, personal information recorded for the transaction, and details about the credit card used in the online payment transaction.

27. The computing device of claim 22, wherein the processor is further configured to determine whether to approve the online payment transaction on the sole basis of the second indication, prior to the first indication being received from the origin issuer server.

28. The computing device of claim 24, wherein the processor is further configured to:
in response to the request transmitted to the third-party advisor server, receive information identifying an alternate origin issuer server for processing the online payment transaction initiated at the computing device; and
transmit a request to the alternate origin issuer server to obtain a third indication of whether the online payment transaction initiated at the computing device should be approved;
wherein, the determining whether to approve the online payment transaction initiated at the computing device is performed based in part on the third indication received from the alternate origin issuer server.

29. The computing device of claim 28, wherein the processor is further configured to:
dismiss the first indication when performing the determining whether to approve the online payment transaction initiated at the computing device.

30. A server comprising a processor and a memory storing instructions for execution by the processor, wherein when the instructions are executed by the processor, the instructions cause the processor to:
receive a request to obtain a second indication of whether an online payment transaction initiated at a computing device should be approved, the second indication having been transmitted in parallel with the transmitting of a request to obtain a first indication of whether the online payment transaction initiated at the computing device should be approved; and
in response to the request to obtain the second indication, transmit the second indication of whether the online payment transaction initiated at the computing device should be approved;
wherein, one or more of the first indication and the second indication is used to determine whether to approve the online payment transaction initiated at the computing device.

31. The server of claim 30, wherein the request to obtain the second indication is received from the virtual issuer server, and the transmitting of the second indication is to the virtual issuer server.

32. The server of claim 30, wherein the request to obtain the second indication is received from the computing device, and the transmitting of the second indication is to the computing device.

33. The server of claim 30, wherein the received request to obtain the second indication comprises information from the online payment transaction.

34. The server of claim 33, wherein the information from the online payment transaction comprises one or more of the following: a Uniform Resource Locator (URL) of the merchant server, an Internet Protocol (IP) address of a merchant server, an IP address of the computing device, personal information recorded for the transaction, and details about the credit card used in the online payment transaction.

35. The server of claim 30, wherein the determining whether to approve the online payment transaction initiated at the computing device is performed on the sole basis of the second indication.

36. The server of claim 30, wherein the processor is further configured to:
transmit information identifying an alternate origin issuer server for processing the online payment transaction initiated at the computing device;
wherein a request is transmitted to the alternate origin issuer server to obtain a third indication of whether the online payment transaction initiated at the computing device should be approved, and
wherein, the determining whether to approve the online payment transaction initiated at the computing device is performed based in part on the third indication received from the alternate origin issuer server.

37. A system for processing electronic payment authorization, the system comprising:
a computing device configured to receive input to initiate an online payment transaction, wherein the computing device is configured to transmit a payment authorization request for the online payment transaction to a merchant server, and the merchant server transmits a corresponding authorization request;
a virtual issuer server for receiving the corresponding authorization request from the merchant server, wherein upon receipt of the corresponding authorization request, the virtual issuer server transmits a request to an origin issuer server to obtain a first indication of whether the online payment transaction initiated at the computing device should be approved; and
a third-party advisor server for receiving a request to obtain a second indication of whether an online payment transaction initiated at a computing device should be approved, the second indication having been transmitted in parallel with the transmitting, to the origin issuer server, of the request to obtain a first indication of whether the online payment transaction initiated at the computing device should be approved;
wherein one or more of the first indication and the second indication is used to determine whether to approve the online payment transaction initiated at the computing device.

38. The system of claim 37, wherein the request to obtain the second indication is received at the third-party advisor server from the virtual issuer server, and in response to the request to obtain the second indication, the third-party advisor server transmits the second indication of whether the online payment transaction initiated at the computing device should be approved to the virtual issuer server.

39. The system of claim 38, wherein the virtual issuer server performs the determination of whether to approve the online payment transaction initiated at the computing device, based on one or more of the first indication and the second indication.

40. The system of claim 37, wherein the request to obtain the second indication is received at the third-party advisor server from the computing device, and in response to the request to obtain the second indication, the third-party advisor server transmits the indication of whether the online payment transaction initiated at the computing device should be approved to the computing device.

41. The system of claim 40, wherein the computing device performs the determination of whether to approve the online payment transaction initiated at the computing device, based on one or more of the first indication and the second indication.
